(19) United States
(12) Patent Application Publication
(10) Pub. No.: US 2025/0270909 A1
(43) Pub. Date: Aug. 28, 2025

(54) ELECTRICAL SUBMERSIBLE PUMPING SYSTEMS AND METHODS

(71) Applicant: Saudi Arabian Oil Company, Dhahran (SA)

(72) Inventors: Jamie Matthew Cochran, Kintore (GB); Rae Andrew Younger, Ellon (GB); Jinjiang Xiao, Dhahran (SA)

(21) Appl. No.: 18/588,695

(22) Filed: Feb. 27, 2024

(51) Int. Cl. E21B 43/12

(52) U.S. Cl. CPC E21B 43/128

(57) ABSTRACT

An electrical submersible pump (ESP) power cable includes a sheathing including a body that includes at least one conductor bore formed therethrough; and at least one power conductor threaded through the at least one conductor bore. The power cable has a density sufficient for the power cable to be at least substantially neutrally buoyant in a wellbore fluid in a wellbore.

### TECHNICAL FIELD

The present disclosure describes apparatus, systems, and methods associated with an electrical submersible pumping system for a wellbore.

### BACKGROUND

Electric submersible pumps used in oil and gas wells are powered by electricity conducted through a cable that is run from a surface motor controller to a pump motor downhole. The cable most commonly includes three separate alternating current (AC) phases of insulated conductor packaged in a round or flat armored configuration. Clamps are used on the cable to secure and protect the cable from mechanical stress, vibration, and other external factors. The cable is usually secured to the tubing or casing using clamps or other mechanical means to prevent the cable from moving or twisting during operation. Any excessive movement or twisting of the cable can cause damage to the conductors or the insulation, which can result in a loss of power or communication with the downhole pump.

### SUMMARY

In an example implementation, a downhole pumping system includes a production tubing installed in a wellbore from a terranean surface to a subterranean formation; a downhole pump coupled to a downhole end of the production tubing and configured to circulate a production fluid from the subterranean formation, through the production tubing, and to the terranean surface; and a power cable electrically coupled to a power supply at the terranean surface and to the downhole pump and configured to supply electrical power to the downhole pump. The power cable is installed in the wellbore and within a wellbore fluid. The power cable has a density sufficient for the power cable to be at least substantially neutrally buoyant in the wellbore fluid.

In an aspect combinable with the example implementation, the power cable is installed in an annulus between the production tubing and the wellbore and within the wellbore fluid in the annulus.

Another aspect combinable with one, some, or all of the previous aspects further includes a production casing installed in the wellbore, the power cable installed in the wellbore in the annulus between the production tubing and the production casing.

Another aspect combinable with one, some, or all of the previous aspects further includes no more than two cable clamps installed to secure the power cable to the production tubing.

In another aspect combinable with one, some, or all of the previous aspects, the no more than two cable clamps include a first cable clamp installed to secure the power cable to the production tubing at a first location at or near a wellbore seal installed in the annulus; and a second cable clamp installed to secure the power cable to the production tubing at a second location at or near a tubing hanger.

In another aspect combinable with one, some, or all of the previous aspects, the no more than two cable clamps include a single cable clamp installed to secure the power cable to the production tubing at either a first location at or near a wellbore seal installed in the annulus or a second location at or near a tubing hanger.

In another aspect combinable with one, some, or all of the previous aspects, the power cable includes a sheathing including at least one conductor bore formed therethrough; and at least one power conductor threaded through the at least one conductor bore.

In another aspect combinable with one, some, or all of the previous aspects, the at least one conductor bore includes three conductor bores, and the at least one power conductor includes three power conductors, and each power conductor is threaded through one of the three conductor bores.

In another aspect combinable with one, some, or all of the previous aspects, the at least one power conductor includes a conductor core including at least one electrically conductive material; an electrical insulative layer that encloses the conductor core; and a metallic tubing that encloses the electrical insulative layer.

In another aspect combinable with one, some, or all of the previous aspects, the at least one electrically conductive material includes aluminum or an aluminum alloy; copper or a copper alloy; or a combination of aluminum and copper.

In another aspect combinable with one, some, or all of the previous aspects, the sheathing includes an outer polymer encapsulation matrix and a low density filler material.

In another aspect combinable with one, some, or all of the previous aspects, the outer polymer encapsulation matrix and the low density filler material forms a syntactic collapse resistant foam.

In another aspect combinable with one, some, or all of the previous aspects, a cross-section shape of the sheathing is a substantially diamond or rhomboid shape.

In another aspect combinable with one, some, or all of the previous aspects, an outer surface of the sheathing includes at least one notch that extends through at least a portion of the outer surface; and at least one pip that extends on the portion of the outer surface, the pip shaped to interface with the notch.

In another aspect combinable with one, some, or all of the previous aspects, a density of the sheathing is about 0.0188 lb./in³.

In another aspect combinable with one, some, or all of the previous aspects, a density of the power cable is about 0.046 lb./in³.

In another aspect combinable with one, some, or all of the previous aspects, the wellbore fluid is brine or a completion fluid.

In another aspect combinable with one, some, or all of the previous aspects, the power cable is installed in the production tubing and within the wellbore fluid in the production tubing.

In another aspect combinable with one, some, or all of the previous aspects, the wellbore fluid is a production fluid.

In another aspect combinable with one, some, or all of the previous aspects, the power cable includes a sheathing including at least one conductor bore formed therethrough, the sheathing including a circular cross section; and at least one power conductor threaded through the at least one conductor bore.

In another aspect combinable with one, some, or all of the previous aspects, the power cable is unconstrained within the production tubing between a cable hanger at or near a terranean surface and a mechanical and electrical connection at the downhole pump.

In another example implementation, an electrical submersible pump (ESP) power cable includes a sheathing including a body that includes at least one conductor bore formed therethrough; and at least one power conductor threaded through the at least one conductor bore. The power cable has a density sufficient for the power cable to be at least substantially neutrally buoyant in a wellbore fluid in a wellbore.

In an aspect combinable with the example implementation, the at least one conductor bore includes three conductor bores, and the at least one power conductor includes three power conductors, and each power conductor is threaded through one of the three conductor bores.

In another aspect combinable with one, some, or all of the previous aspects, the at least one power conductor includes a conductor core including at least one electrically conductive material; an electrical insulative layer that encloses the conductor core; and a metallic tubing that encloses the electrical insulative layer.

In another aspect combinable with one, some, or all of the previous aspects, the at least one electrically conductive material includes: aluminum or an aluminum alloy; copper or a copper alloy; or a combination of aluminum and copper.

In another aspect combinable with one, some, or all of the previous aspects, the body includes an outer polymer encapsulation matrix and a low density filler material.

In another aspect combinable with one, some, or all of the previous aspects, the outer polymer encapsulation matrix and the low density filler material forms a syntactic collapse resistant foam.

In another aspect combinable with one, some, or all of the previous aspects, a cross-section shape of the body is a substantially diamond or rhomboid shape.

In another aspect combinable with one, some, or all of the previous aspects, an outer surface of the body includes at least one notch that extends through at least a portion of the outer surface; and at least one pip that extends on the portion of the outer surface, the pip shaped to interface with the notch.

In another aspect combinable with one, some, or all of the previous aspects, a density of the body is about 0.0188 lb./in³.

In another aspect combinable with one, some, or all of the previous aspects, a density of the ESP power cable is about 0.046 lb./in³.

In another aspect combinable with one, some, or all of the previous aspects, the body includes at least one capillary bore formed therethrough.

In another aspect combinable with one, some, or all of the previous aspects, the at least one capillary bore is configured to carry a data telemetry conductor or a fluid.

In another aspect combinable with one, some, or all of the previous aspects, the density is sufficient for the power cable to be at least substantially neutrally buoyant in the wellbore fluid in an annulus between a production casing and a production tubing.

In another aspect combinable with one, some, or all of the previous aspects, the density is sufficient for the power cable to be at least substantially neutrally buoyant in the wellbore fluid within a production tubing.

In another example implementation, a method of supplying power to a downhole pump includes installing a downhole pump at or near a downhole end of a production tubing installed in a wellbore from a terranean surface to a subterranean formation; running a power cable through the wellbore and within a wellbore fluid in the wellbore, the power cable having a density sufficient for the power cable to be at least substantially neutrally buoyant in the wellbore fluid; electrically coupling the power cable to a power supply at the terranean surface and to the downhole pump; supplying electrical power to the downhole pump from the power supply and through the power cable; and operating the downhole pump to circulate a production fluid from the subterranean formation, through the production tubing, and to the terranean surface.

An aspect combinable with the example implementation includes running the production tubing into the wellbore formed from the terranean surface to the subterranean formation; and coupling the downhole pump to the downhole end of the production tubing.

Another aspect combinable with one, some, or all of the previous aspects further includes securing the power cable to the production tubing with no more than two cable clamps.

In another aspect combinable with one, some, or all of the previous aspects, securing the power cable to the production tubing with no more than two cable clamps includes securing the power cable to the production tubing with a first cable clamp installed at a first location at or near a wellbore seal installed in the annulus; and securing the power cable to the production tubing with a second cable clamp installed at a second location at or near a tubing hanger.

In another aspect combinable with one, some, or all of the previous aspects, securing the power cable to the production tubing with no more than two cable clamps includes securing the power cable to the production tubing with a single cable clamp installed at either a first location at or near a wellbore seal installed in the annulus or a second location at or near a tubing hanger.

In another aspect combinable with one, some, or all of the previous aspects, the power cable includes a sheathing including at least one conductor bore formed therethrough; and at least one power conductor threaded through the at least one conductor bore, and the method includes spooling the power cable from a spooling system at or near a rig floor near an entry of the wellbore; and supplying electrical power to the downhole pump from the power supply through the at least one power conductor.

In another aspect combinable with one, some, or all of the previous aspects, supplying electrical power to the downhole pump from the power supply through the at least one power conductor includes supplying electrical power to the downhole pump from the power supply through three power conductors, with each power conductor threaded through one of three conductor bores.

In another aspect combinable with one, some, or all of the previous aspects, supplying electrical power to the downhole pump from the power supply through the at least one power conductor includes supplying electrical power to the downhole pump from the power supply through a conductor core of the at least one power conductor, the conductor core included of at least one electrically conductive material.

In another aspect combinable with one, some, or all of the previous aspects, the at least one electrically conductive material includes aluminum or an aluminum alloy; copper or a copper alloy; or a combination of aluminum and copper.

In another aspect combinable with one, some, or all of the previous aspects, the power cable is spooled on a drum of the spooling system such that an outer surface of the sheathing of a first portion of the power cable interfaces at an interface location with an outer surface of the sheathing of a second portion of the power cable.

In another aspect combinable with one, some, or all of the previous aspects, the interface location includes an interface between at least one notch that extends through the outer surface of the sheathing; and at least one pip that extends on the outer surface and is shaped to interface with the notch.

Another aspect combinable with one, some, or all of the previous aspects further includes running the power cable through the wellbore in the production tubing; and running the downhole pump into the production tubing on the power cable acting as a downhole conveyance.

Implementations of a downhole pump system according to the present disclosure may include one or more of the following features. For example, a downhole pump system according to the present disclosure can eliminate or reduce power cable damage during installation by using a crush resistant, low friction, neutrally buoyant and streamlined-shaped cable that can avoid and/or survive crushing forces and impacts imparted during deployment and retrieval operations. As another example, a downhole pump system according to the present disclosure can increase operational reliability (and therefore run life) of a power cable for a downhole pump through corrosion resistant materials and a full high-pressure barrier integrity. Further, a downhole pump system according to the present disclosure can help speed up running and retrieval operation with a workover/drilling rig by eliminating most if not all cable clamps used to constrain a power cable to a wellbore tubular, which are time consuming to install and remove. As a further example, a downhole pump system according to the present disclosure can enable a reduction of exposure of service personnel to hazardous conditions on the rig floor and vicinity by eliminating labor-intensive clamping operations to install or remove cable clamps. As another example, a downhole pump system according to the present disclosure can reduce a likelihood of accidental dropped items into a wellbore (which can be time consuming to retrieve) based on a reduction of cable clamps that are used to secure a power cable to a wellbore tubular.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example implementation of a downhole pump system according to the present disclosure.

FIG. 2A is a schematic diagram of an example implementation of a downhole pump assembly within a production system according to the present disclosure.

FIG. 2B is a schematic diagram of another example implementation of a downhole pump assembly within a production system according to the present disclosure.

FIG. 2C is a schematic diagram of another example implementation of a downhole pump assembly within a production system according to the present disclosure.

FIG. 3A is a downhole, cross-sectional view of the production system of FIG. 2A that includes an ESP power cable according to the present disclosure.

FIG. 3B is a downhole, cross-sectional view of another example production system that includes dual ESP power cables according to the present disclosure.

FIG. 3C is a downhole, cross-sectional view of the example production system of FIG. 2B or 2C that includes an ESP power cable according to the present disclosure.

FIGS. 4A and 4B are illustrations of a portion of an example implementation of an ESP power cable according to the present disclosure.

FIGS. 5 and 6 are scaled drawings of example implementations of a portion of a sheathing for an ESP power cable according to the present disclosure.

FIG. 7 is a schematic diagram of an example implementation of a spooled ESP power cable according to the present disclosure.

FIGS. 8A-8C are illustrations of other example implementations of a portion of a sheathing for an ESP power cable according to the present disclosure.

### DETAILED DESCRIPTION

The present disclosure describes example implementations of a downhole pumping system and, more particularly, an electric submersible pump (ESP) system that includes a power cable (or multiple power cables) that has a sufficiently low enough density to be approximately neutrally buoyant (i.e., neither sinking nor floating) in a fluid (for example, liquid brine from a subterranean formation) that is found in an annulus through which the power cable extends to the downhole ESP. By being approximately neutrally buoyant in a fluid, most or all of a required support for the power cable within the wellbore can be eliminated. Further, unnecessary constraints to the power cable within the wellbore (typically constraints in the form of multiple cable bands at one clamp per 30 feet of power cable) can be eliminated or at least greatly reduced (for example, to only one or two cable clamps between a tubing hanger and a production packer).

As noted, a power cable for an ESP according to the present disclosure can be neutrally buoyant or substantially neutrally buoyant in a wellbore fluid in which the cable is run. In some aspects, the power cable is neutrally buoyant as the density of the power cable (as determined by the specific densities of the components that make up the power cable) is equal to a density of the wellbore fluid (such as brine). However, the power cable can be substantially neutrally buoyant taking into account variations in density of the wellbore fluid due to, for example, a pressure gradient in the wellbore and thus the wellbore fluid, as well as variations in the density of the wellbore fluid due to the compressibility of the fluid. Further, variations of temperature within the wellbore can provide for density variations in the wellbore fluid as well. Also, there can be variations in density of the power cable over its length due to, for example, a manufacturing process that produces the power cable. Thus, in example aspects of the present disclosure, the power cable can be substantially neutrally buoyant in the wellbore fluid when the density of the power cable does not exactly equal (but is close to) the density of the wellbore fluid at all points along a length of the power cable in the wellbore (for example, in an annulus between a production tubular and a casing or wellbore wall, or in the production tubular).

The elimination of the cable clamp constraints (one, some, or all) can provide a freedom of movement of the power cable within the annulus to avoid crushing due to movement of the production tubing within the production casing. In example aspects as well, a shape of a power cable sheathing (that makes up one component of the power cable) can be optimized to ensure that contact friction between the production tubing and the production casing is biased to cause a vector reaction force that moves the power cable to an area of clearance within the annulus between tubing and casing, thereby minimizing the chance of damage to the power cable through crushing.

Example implementations of an ESP power cable according to the present disclosure can provide for a neutrally buoyant cable construction through the use of aluminum (or an aluminum alloy) as the conductor (or conductors) within the power cable. Indeed, aluminum conductors have been used in high voltage transmission lines and other electrical applications for many decades due to its high conductivity, light weight, and relatively low cost compared to copper, but are not typically used in a wellbore application. Aluminum conductors also have some advantages over copper conductors in certain applications. For example, aluminum conductors can carry up to 1.5 times the current of an equivalent copper conductor for the same weight, which can be beneficial for use in cables that are hung vertically in wellbores.

However, aluminum is more resistive than copper, and therefore a larger volume of conductor may be required for the equivalent electrical resistance of a conductor cable, meaning a larger cross section of wire is needed to substitute a copper conductor with aluminum. Another means of reducing the volume of conductor in a cable would be to increase the transmission voltage to reduce the current which in turn reduces the resistance losses across a long length. To enable this, improved insulation on each conductor is required to prevent insulation breakdown as provided with the sheathing of the example implementations of the power cable described herein.

Further, aluminum tends to corrode more than copper which is a downside of using aluminum as a conductor in a harsh corrosive environment such as in a wellbore. This downside can be mitigated by encapsulating each electrical conductor phase in a corrosion resistant metal tube to isolate the aluminum from contaminants for the lifetime of the cable, as is described in example implementations herein. Additional example implementations of an ESP power cable according to the present disclosure can provide for a neutrally buoyant cable construction through the use of Carbon Nano-Tube (CNT) or CNT-copper composite materials for enhanced conductivity-to-weight ratio performance can be implemented in the example power cables for the ESP.

In example aspects according to the present disclosure, a sheathing that is part of the ESP power cable can be formed of a syntactic buoyancy material or similarly low-density material to reduce the overall density of the cable assembly. For example, in some aspects, the sheathing can be a composite material using a lightweight filler and a thermoplastic matrix, also known as a syntactic foam, which are typically made up of hollow glass or ceramic microspheres embedded in a matrix material, such as epoxy, polyurethane or polyamide. By incorporating syntactic foam into the sheathing of an ESP power cable according to the present disclosure, the overall density of the cable can be reduced while maintaining its structural integrity and strength. This can be important for applications where the cable needs to be submerged deep in water or other fluids, such as in the annulus of a wellbore for oil and gas production. The reduced density of the syntactic buoyancy material can also reduce a load on the power cable due to the weight of the cable and enable substantially fewer supporting clamps to be fitted around the power cable and to, for example, the production tubing.

By reducing a number of clamps necessary to constrain the example implementations of the power cable of the present disclosure to a wellbore tubular, such as production tubing, there is a reduced risk of damage to the power cable during clamping, running and retrieval. Further, for particularly tight clearance applications between the production casing and the production tubing, implementations of the power cable according to the present disclosure can replace a conventional, flat three-phase cable (as opposed to a larger round cable used in larger clearance applications) that is conventionally run to increase a space and reduce a chance of damage of the power cable due to abrasion, impact, and crushing (for example, while running or otherwise). Additionally, as the process of clamping the power cable is time consuming and requires several personnel, a reduction in the number of clamps used to constrain the power cable in the wellbore can create a more efficient and less costly installation process for the ESP.

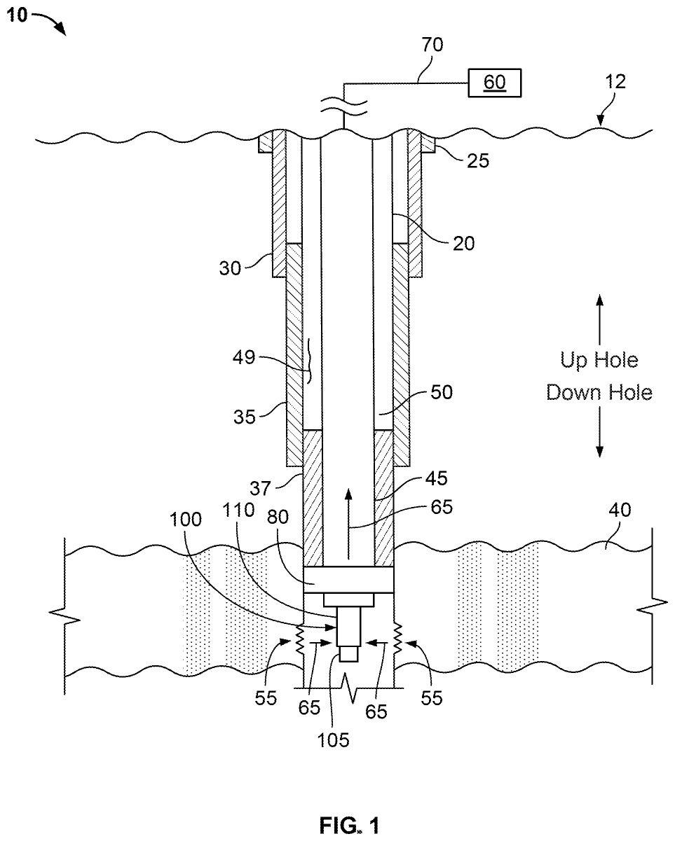

FIG. 1 is a schematic diagram of an example implementation of a downhole pumping system 10 including a downhole pump assembly 100. Generally, FIG. 1 illustrates at least a portion of one implementation of the downhole pumping system 10 according to the present disclosure in which the downhole pump assembly 100 may be run into a wellbore 20 on a wellbore tubular 45 (for example, a production tubing 45) within the wellbore 20. In this example, an uphole end of the downhole pump assembly 100 is coupled to the production string 45 while the downhole pump assembly 100 is positioned adjacent a subterranean reservoir 40. Alternatively, downhole pumping system 10 can also represent a system in which the downhole pump assembly 100 is run into the wellbore 20 on a power cable 70 through and within the production tubing 45, rather than on the production tubing 45.

In this example implementation, the downhole pump assembly 100 comprises an electric submersible pump (ESP) 100 that is operable to circulate a wellbore fluid 65, such as a hydrocarbon fluid (for example, oil, gas, or a mixture thereof) from the subterranean reservoir 40 to a terranean surface 12. In some aspects, the ESP 100, as shown, is positioned on the production string 45 below a wellbore seal 80 (for example, a packer or other seal) that is positioned in the wellbore 20. An annulus 50 is defined between the production string 45 and the wellbore 20.

As shown in FIG. 1, one or more power cables 70 provide electrical power to the ESP 100 from a power supply system 60 at the terranean surface 12. In example implementations, each of the one or more power cables 70 has a sufficiently low enough density to be approximately neutrally buoyant in a fluid 49 (for example, liquid brine from a subterranean formation or as a completion liquid, or a mixed-phase fluid) that is found in an annulus through which the power cable 70 extends to the downhole ESP 100. In alternative implementations, each of the one or more power cables 70 has a sufficiently low enough density to be approximately neutrally buoyant in a production fluid 65 that is circulated through the production tubing 45 in cases in which the power cable 70 is used as a downhole conveyance to run the downhole ESP 100 into the wellbore 20 and through the production tubing 45. By being approximately neutrally buoyant in a fluid, most or all of a required support for the power cable 70 within the wellbore 20 can be eliminated.

For example, power cable 70 can be manufactured by encapsulating one or more (and optimally, three for three phase power delivery) conductors into a sheathing that has a cross-sectional shape so as to promote buoyancy and also help eliminate possible crushing between the production tubing 45 and a production casing 37 (which is optional as the wellbore 20 can be uncased and open hole completed). As the wellbore 20 can be filled with a completion fluid 49 (typically brine) of a known density (typically significantly greater than fresh water), the sheathing can be formed of a material (for example, a thermoplastic polymer such as a polyamide with syntactic fillers) to allow the power cable 70 to be substantially buoyant within the completion fluid 49 of the wellbore 20. Alternatively, as the production tubing 45 can be filled with the production fluid 65 of a known density, the sheathing can be formed of a material (for example, a thermoplastic polymer such as a polyamide with syntactic fillers) to allow the power cable 70 to be substantially buoyant within the production fluid 65 of the wellbore 20.

As shown, the downhole pumping system 10 accesses the subterranean formation 40 and provides access to hydrocarbons (for example, the production fluid 65) located in such subterranean formation 40. In an example implementation of system 10, the system 10 may be used for a production operation in which the hydrocarbons may be produced from the subterranean formation 40 through the downhole pump assembly 100 and to the wellbore tubular 45 (for example, as a production tubing 45) uphole of the downhole pump assembly 100.

A drilling assembly (not shown) may be used to form the wellbore 20 extending from the terranean surface 12 and through one or more geological formations in the Earth. One or more subterranean formations, such as subterranean zone 40, are located under the terranean surface 12. As will be explained in more detail below, one or more wellbore casings, such as a surface casing 30, intermediate casing 35, and a production casing 37 can be installed in at least a portion of the wellbore 20. In some implementations, a drilling assembly used to form the wellbore 20 may be deployed on a body of water rather than the terranean surface 12. For instance, in some implementations, the terranean surface 12 may be an ocean, gulf, sea, or any other body of water under which hydrocarbon-bearing formations may be found. In short, reference to the terranean surface 12 includes both land and water surfaces and contemplates forming and developing one or more downhole pumping systems 10 from either or both locations.

In some implementations of the downhole pumping system 10, the wellbore 20 is cased with one or more casings. As illustrated, the wellbore 20 includes a conductor casing 25, which extends from the terranean surface 12 shortly into the Earth. A portion of the wellbore 20 enclosed by the conductor casing 25 may be a large diameter borehole. Additionally, in some implementations, the wellbore 20 may be offset from vertical (for example, a slant wellbore). Even further, in some implementations, the wellbore 20 may be a stepped wellbore, such that a portion is drilled vertically downward and then curved to a substantially horizontal wellbore portion. Additional substantially vertical and horizontal wellbore portions may be added according to, for example, the type of terranean surface 12, the depth of one or more target subterranean formations, the depth of one or more productive subterranean formations, or other criteria.

Downhole of the conductor casing 25 may be the surface casing 30. The surface casing 30 may enclose a slightly smaller borehole and protect the wellbore 20 from intrusion of, for example, freshwater aquifers located near the terranean surface 12. The wellbore 20 may than extend vertically downward. This portion of the wellbore 20 may be enclosed by the intermediate casing 35 or the production casing 37 (or both). Any of the illustrated casings, as well as other casings that may be present in the downhole pumping system 10, may include one or more casing collars.

In this example implementation of the downhole pumping system 10, the downhole pump assembly 100 includes a pump 110 coupled to an electric motor 105 (for example, that collectively form the ESP 100). In this example, the wellbore seal 80 is set just uphole of one or more perforations 55 (for example, made in a casing of the wellbore 20) that fluidly couple the subterranean reservoir 40 to the wellbore 20. The electric motor 105 can be operated by electric power provided by the one or more power cables 70. Upon activation, for example by the power supply system 60, the electric motor 105 activates the pump 110 to circulate the production fluid 65 through the perforations 55, into one or more inlets of the pump 110, and into the production string 45 toward the terranean surface 12 as shown.

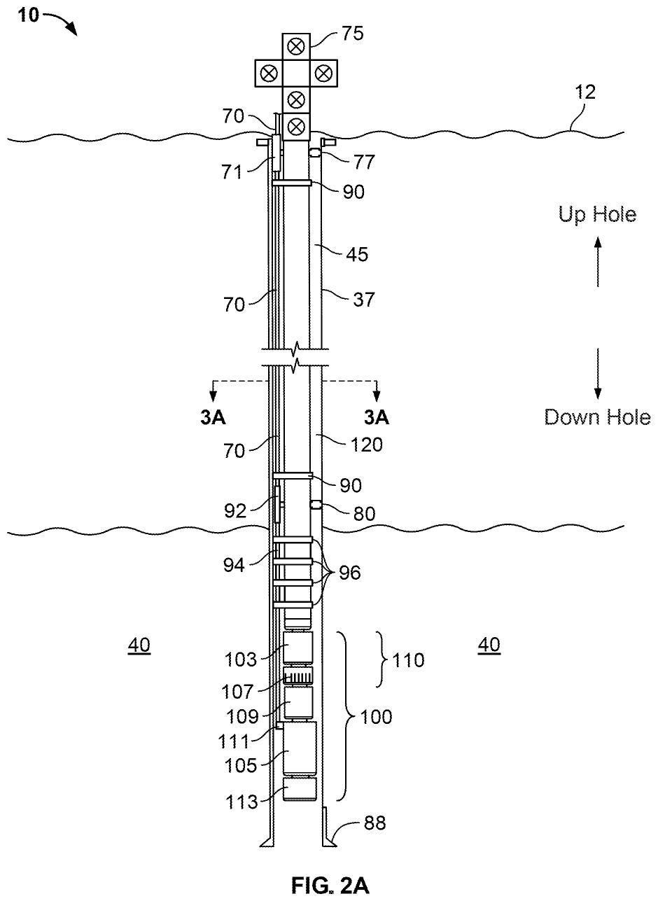

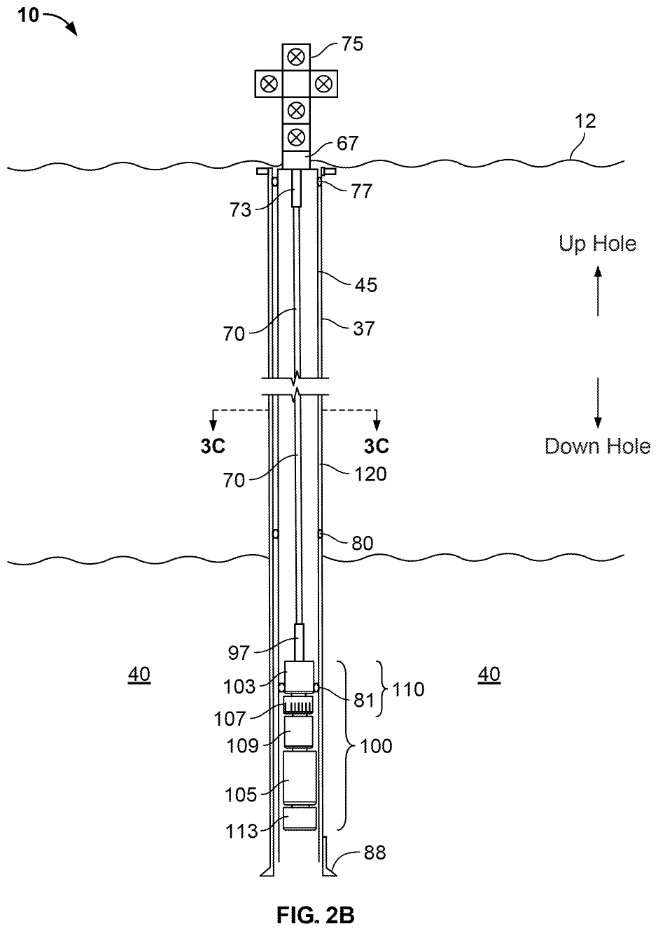

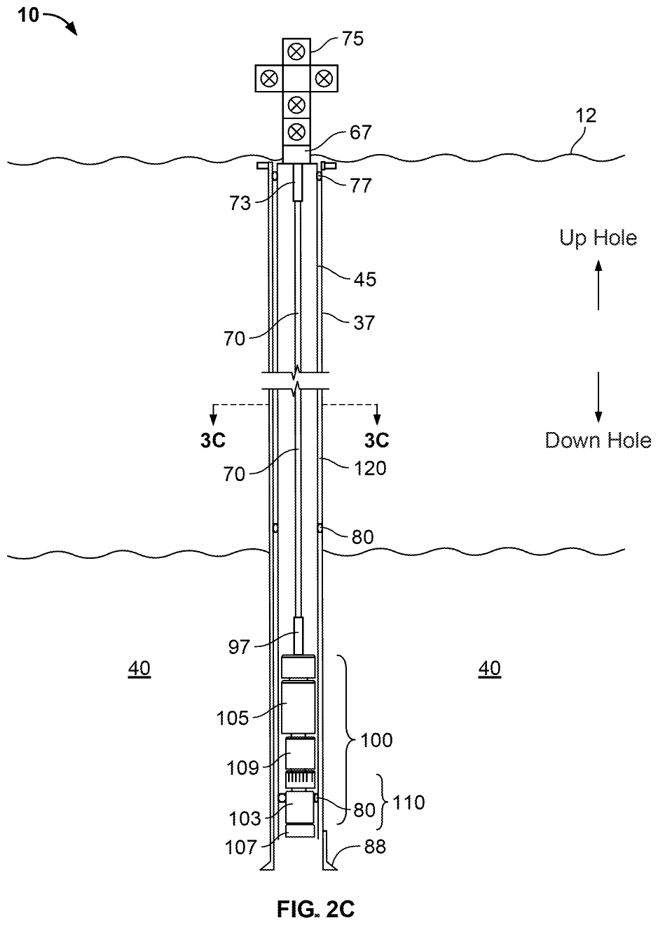

FIG. 2A is a schematic diagram of an example implementation of the downhole pump assembly 100 within the downhole pumping system 10 according to the present disclosure. FIG. 2A shows a more detailed view of components of the downhole pumping system 10 and, an example configuration in which the power cable 70 is electrically coupled to the downhole pump assembly (or ESP) 100. As shown in this figure, a wellhead tree 75 (colloquially known as a Christmas tree) is positioned on the wellbore to control a production fluid from the production tubing 45 that is positioned within the production casing 37.

The production tubing 45 (or “string”) is coupled at a downhole end to the ESP 100. The ESP 100 includes the pump 110 that is made up of a pump intake 107 and a pump section 103. A seal/protector 109 of the ESP 100 couples the pump intake 107 to the motor 105. A gauge 113 is coupled to a downhole end of the motor 105.

In this example implementation, electrical power is provided to the pump motor 105 at a motor pothead connection 111, which electrically couples a motor lead extension 94 to the motor 105. In turn, the motor lead extension 94 is electrically coupled to the power cable 70 (and, optionally, more than one power cable 70) at a production power electrical penetrator 92. The penetrator 92 provides a connection or electrical path though seal 80 (or production packer 80) to connect to the power cable 70. In turn, the power cable 70 is extended uphole to a wellhead electrical penetrator 71 and, ultimately a source of electrical power (such as the power supply system 60 at the terranean surface 12).

Thus, as shown in this example implementation, the production tubing 45 extends through the production packer 80 and couples to the ESP 100. The power cable 70 extends to the production packer 80 and electrically connects to the motor lead extension 94 to complete a circuit (from power supply system 60 to the pump motor 105) that includes the power cable 70, production packer electrical penetrator 92, the motor lead extension 94, and the motor pothead connection 111. Through this circuit, electrical power can be provided to operate the ESP 100 to circulate production fluid 65 (for example, oil, gas, water, or a combination thereof) to the terranean surface 12 through wellhead tree 75.

As shown in this example, multiple motor lead extension cable clamps (MLE cable clamps) 96 are installed to constrain the motor lead extension 94 to the production tubing 45. Conventionally, MLE cable clamps 96 can be installed at a particular number per unit length of the motor lead extension 94 to constrain the motor lead extension 94 (for example, to prevent damage to the extension 94 or otherwise during relative movement between the production tubing 45 and the production casing 37).

However, as shown in this example, the power cable 70 can be constrained within an annulus 120 between the production tubing 45 and the production casing 37 by a minimal number of cable clamps 90 rather than, as is conventional, a number of cable clamps per unit length of the power cable 70. For instance, as shown in this example, there are two cable clamps 90 that secure the power cable 70 to the production tubing 45 and constrain movement of the power cable 70 within the annulus 120 between the production tubing 45 and the production casing 37. One of the two cable clamps 90 can be an upper cable clamp 90 that secures the power cable to the production tubing 45 at or near (i.e., just downhole of) a tubing hanger 77. Another of the two cable clamps 90 can be a lower cable clamp 90 that secures the power cable to the production tubing 45 at or near (i.e., just uphole of) the production packer 80. Thus, in this example implementation, the power cable 70 is only secured to the production tubing 45 (or other wellbore tubular within the wellbore) by two cable clamps 90 within a section of the wellbore between the tubing hanger 77 and the production packer 80.

As another example, cable clamps 90 between the tubing hanger 77 and the production packer 80 can be eliminated. For example, due to the buoyant nature of the power cable 70 within the brine 49 in the annulus 120, constraint of the power cable 70 to the production tubing 45 may be unnecessary (and still avoid damage due to, for example, relative movement of the production tubing 45 within the production casing 37. For instance, a sheathing and conductors of the power cable 70 can be selected or designed for unconstrained buoyancy within the brine 49 based on the density (or other characteristics) of the brine 49. However, in some aspects, due to variation of brine density due to, for example, temperature differences within the wellbore, at least one cable clamp 90 (for example, either an upper cable clamp 90 or lower cable clamp 90 or a cable clamp between the tubing hanger 77 and the production packer 80) can be used to secure the power cable 70 to the production tubing 45.

As yet another example implementation, there can be more than two cable clamps 90 installed to secure the power cable 70 to the production tubing 45, but less than, for example, a conventional number of cable clamps at 1 clamp per 30 feet of power cable 70. For example, the clamp per power cable length can be an order of magnitude less, such as 1 clamp per 300 feet of power cable 70, or even less.

Less cable clamps 90 (and in some aspects, considerably less) can be used to secure the power cable 70 to the production tubing 45 due to the buoyant nature of the power cable 70 within the brine 49. Whether the number of cable clamps 90 between the tubing hanger 77 and production packer 80 is zero, one, two, or some number of clamp per power cable length that is less than 1 clamp per 30 feet, the buoyant nature of the power cable 70 within the brine 49 allows the power cable 70 to remain unconstrained but also undamaged (completely or mostly) by avoiding a crushing impact when the production tubing 45 moves relative to the production casing 37.

A buoyant force of the power cable 70 can be designed or achieved due to a number of factors, such as a known or determined density of the brine 49, a material of the conductors of the power cable 70 (for example, copper, aluminum, or otherwise), and a material of a sheathing that encloses the conductors of the power cable 70 (as described in more detail herein). These factors can be used to select or design a particular density of the power cable 70 to provide a desired buoyant force of the power cable 70 in the annulus 120 and within the brine 49. As an example, the density of the power cable 70 can be about 0.046 lb./in³.

FIG. 2B is a schematic diagram of an example implementation of the downhole pump assembly 100 within the downhole pumping system 10 according to the present disclosure. FIG. 2B shows an example configuration in which the power cable 70 is electrically coupled to the downhole pump assembly (or ESP) 100 through the production tubing 45 rather than the annulus 120. In this example, therefore, the power cable 70 acts as the power conveyance from the power supply system 60 to the ESP 100, as well as a downhole conveyance on which the ESP 100 is run into and out of the wellbore 20.

As shown in this example, the power cable 70 connects to the ESP 100 at a mechanical and electrical connection 97, and a pump packer 81 is also positioned to seal the annulus 120 at an uphole end of the ESP 100. The power cable 70 extends through the production tubing 45 and, in example aspects, is substantially unconstrained (for example, no cable clamps or other constraints) within the production tubing 45, being connected only to a wellhead electrical penetrator spool 67 at an uphole end and to the mechanical and electrical connection 97 at a downhole end. A cable hanger 73 helps connect the power cable 70 to the wellhead electrical penetrator spool 67.

As shown in this example implementation, the production tubing 45 extends through the production packer 80 and extends past the ESP 100 in the wellbore 20. The power cable 70 extends through the production tubing 45 to the ESP 100 to complete a circuit (from power supply system 60 to the pump motor 105). Through this circuit, electrical power can be provided to operate the ESP 100 to circulate production fluid 65 (for example, oil, gas, water, or a combination thereof) to the terranean surface 12 through wellhead tree 75.

As noted here, the power cable 70 is largely unconstrained within the production tubing 45 and, due its substantially buoyant construction, supports its own weight in the production fluid 65. Generally, ESP power cables that are also used as the downhole conveyance mechanism must be stronger than a (conventional) ESP cable and support its own weight plus the operational loads during install of the ESP and retrieval of the ESP. These loads usually require reinforcement members to be added to an ESP power cable, adding cost and weight. Further, unconstrained ESP power cables tend to stretch significantly, and this can be problematic for the conductor insulation which can stretch at different rates, leading to electrical insulation breakdown.

In contrast, as described, power cable 70 is substantially neutrally buoyant taking into account variations in density of the production fluid 65. Thus, in example aspects of FIGS. 2B (and 2C), the power cable 70 can be substantially neutrally buoyant in the production fluid 65 when the density of the power cable 70 does not exactly equal (but is close to) the density of the production fluid 65 at all points along a length of the power cable 70 within the production tubing 45 unconstrained between the cable hanger 73 and the mechanical and electrical connection 97.

A buoyant force of the power cable 70 in FIGS. 2B (and 2C) can be designed or achieved due to a number of factors, such as a known or determined density of the production fluid 65, a material of the conductors of the power cable 70 (for example, copper, aluminum, or otherwise), and a material of a sheathing that encloses the conductors of the power cable 70 (as described in more detail herein). These factors can be used to select or design a particular density of the power cable 70 to provide a desired buoyant force of the power cable 70 in the production tubing 45 and within the production fluid 65.

In some aspects, the production fluid 65 can be considerably lighter than the wellbore fluid 49 (for example, brine). Thus, for the example implementation of FIGS. 2B and 2C, the power cable 70 can have a lower density as a desired buoyant force will be less in these implementations as compared to the implementation of FIG. 2A. Also, in some aspects, in order to balance forces, a cross-sectional area of the cable may need to be increased, and the composite density of the power cable 70 can be less than that as described with reference to FIG. 2A. For example, the density of the power cable 70 in FIGS. 2B and 2C can be about 0.03-0.05 lb./in³.

FIG. 2C is a schematic diagram of another example implementation of the downhole pump assembly 100 within the downhole pumping system 10 according to the present disclosure. FIG. 2C shows another example configuration in which the power cable 70 is electrically coupled to the downhole pump assembly (or ESP) 100 through the production tubing 45 rather than the annulus 120. FIG. 2C shows a configuration in which the ESP 100 is a non-inverted electrical submersible pump, whereas FIG. 2B shows a configuration in which the ESP 100 is an inverted electrical submersible pump. As shown in these examples, the positioning of the pump packer 81 can depend on the orientation of the ESP 100 in the production tubing 45.

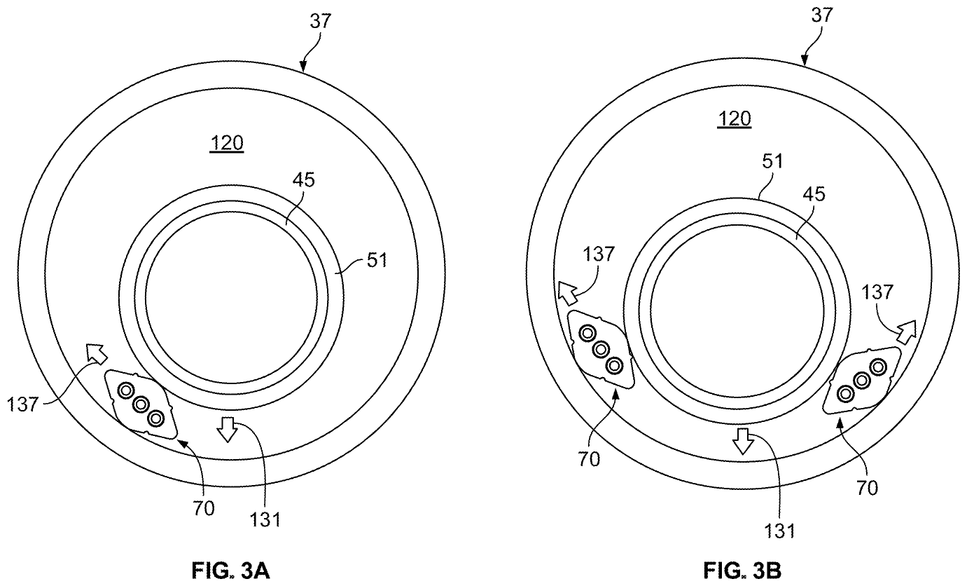

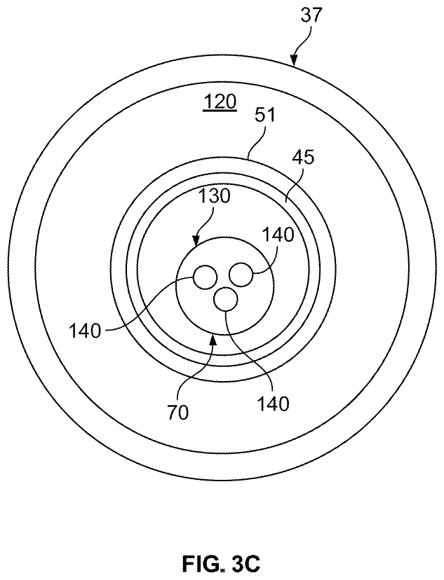

FIG. 3A is a downhole, cross-sectional view of the downhole pumping system 10 of FIG. 2A that includes the ESP power cable 70. As shown in this example, a single power cable 70 is installed in the annulus 120 and between the production tubing 45 and the production casing 37. In this example, a production tubing coupling 51 is shown attached to the production tubing 45 as well.

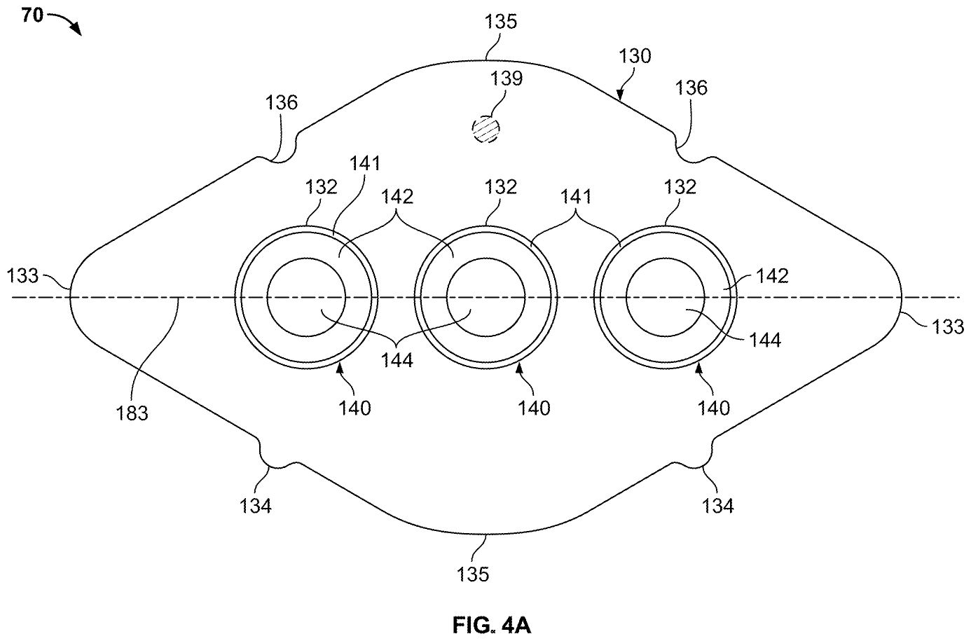

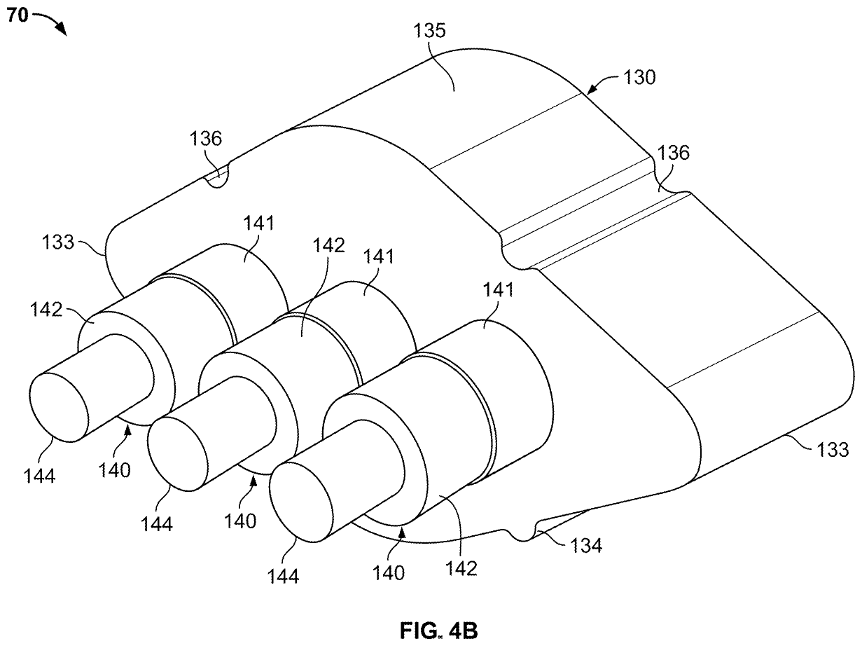

In this example implementation, the cross-section of the power cable 70 is approximately diamond in shape as shown (with further detail provided in FIGS. 4A and 4B). Due in part to this shape, as well as the largely unconstrained positioning of the power cable 70 within the annulus 120 (for example, due to minimal or no cable clamps 90) and the buoyant nature of the cable 70, the power cable 70 can react in response to a movement vector 131 of the production tubing 45 to avoid being crushed between the production tubing 45 and the production casing 37. For instance, as shown in this example, the power cable 70 can move with a reaction vector 137 in response to the movement vector 131.

FIG. 3B is another downhole, cross-sectional view of the downhole pumping system 10 of FIG. 2A that includes two ESP power cables 70 (for example, a primary and secondary power cable). As shown in this example, the two power cables 70 are installed in the annulus 120 and between the production tubing 45 and the production casing 37. In this example, the production tubing coupling 51 is shown attached to the production tubing 45 as well.

In this example implementation, the cross-section of each of the power cables 70 is approximately diamond in shape as shown (with further detail provided in FIGS. 4A and 4B). Due in part to this shape, as well as the largely unconstrained positioning of the power cables 70 within the annulus 120 (for example, due to minimal or no cable clamps 90) and the buoyant nature of the cables 70, the power cables 70 can react in response to the movement vector 131 of the production tubing 45 to avoid being crushed between the production tubing 45 and the production casing 37. For instance, as shown in this example, the power cables 70 can move with respective reaction vectors 137 in response to the movement vector 131.

FIG. 3C is a downhole, cross-sectional view of the downhole pumping system 10 of FIG. 2B or 2C that includes the ESP power cable 70 run into the wellbore 20 through the production tubing 45 rather than the annulus 120 (and connected as the power supply and mechanical downhole conveyance for ESP 100). As shown in this example, a single power cable 70 is installed in the production tubing 45, but additional power cables 70 can also be implemented without departing from the scope of this disclosure. In this example, the production tubing coupling 51 is shown attached to the production tubing 45 as well.

In this example implementation, the cross-section of the power cable 70 is circular or approximately circular as shown; however, the cross-sectional shape of the power cable 70 employed in the example configurations of FIGS. 2B and 2C can also be diamond or rhomboid or oval (or other shapes disclosed herein and within the scope of this disclosure). A round cross-section of power cable 70 may be cost efficient and utilized within the production tubing 45 due to the minimal or reduced chance of “crushing” due to relative movement of the production tubing 45 and production casing 37.

FIGS. 4A and 4B are illustrations of a portion of an example implementation of the ESP power cable 70 according to the present disclosure. FIG. 4A shows a front view of the portion of the power cable 70, while FIG. 4B shows an isometric view of the portion of the power cable 70. Taking both figures into account, generally, the power cable 70 includes one or more conductors 140 encased within a sheathing 130. In this example, there are three conductors 140 (to provide three phase power through power cable 70). Further, as first referenced in FIGS. 3A and 3B, the sheathing 130 comprises a diamond-shape cross section having rounded edges 135 and corner edges 133.

For example, the cross-section shape of the sheathing 130 can be diamond or rhomboid in shape with one or two lines of symmetry. Opposite angles of the shape are congruent with diagonals perpendicular, i.e., a parallelogram in which adjacent sides are of unequal lengths and angles are non-right angled. The corners of the outer cross-sectional face of the sheathing 130 can have curved radii features.

In this example implementation, the sheathing 130 is comprised of, for example, a thermoplastic lightweight filler matrix that contributes to the buoyant nature of the power cable 70. For example, the sheathing 130 can be made of a polymer with syntactic fillers. Example polymers can include HDPE, PP, ETFE, FEP, PFA or PA. The polymer can be mixed or contain a low density filler material to form a syntactic collapse resistant foam sufficient to withstand downhole pressures (for example, up to 5,000 psi). The outer polymer can be of sufficiently low density (for example, about 0.5-0.6 SG). In some aspects, the cross-sectional area of the sheathing 130 can be varied during manufacture and tuned/matched to be within +/−5% neutral buoyant in the brine 49 (which can have a known density range).

A specific example material of the sheathing 130 can include PA12 (i.e., Polyamide 12) and 50% by weight of Glass Bubble S32HS made by 3M™ (https://www.3m.co.uk/3M/en_GB/p/d/b5005035032/). For this example, the density of the sheathing 130 is about 0.0188 lb./in³. However, the selected material(s) for the sheathing 130 can depend on many factors including, but not limited to, density, pressure collapse resistance, abrasion resistance, friction properties, and others.

Other example materials for the sheathing 130 can also be used. For example, as one option, the sheathing 130 can be formed of a durable and robust outer polymer encapsulation that provides cut resistance, such as an aramid (Kevlar) or carbon fiber weave. As another option, the sheathing 130 can be formed of) a durable and robust outer layer of polymer encapsulation that provides abrasion resistance, such as PEEK, metal spheres, or ceramic material particles.

In this example implementation, one or more (two in this example) notches 136 are formed on a portion of an outer surface of the sheathing 130, while one or more (two in this example) pips 134 are formed on another portion of the outer surface of the sheathing 130. In this example, the notches 136 and pips 134 are formed on opposing surfaces of the sheathing 130 and, as explained in more detail herein, can help align the power cable 70 onto itself when spooled onto a drum or other storage device. Further, in some aspects, the pips 134 can act as fulcrums (or pivot points) to rotate or pivot the power cable 70 away from a production tubing 45 or production casing 37 when movement of either of these two tubulars places the power cable 70 in contact (at a pip 134) with one of these two wellbore components.

Continuing the example implementation of FIGS. 4A and 4B, each conductor 140 can include several components. For example, each conductor 140 (which extends through a bore 132 formed through the sheathing 130) includes a steel tube 141, which encapsulates an electrical insulation layer 142, which encapsulates a conductor core 144. In some aspects, the steel tube 141 can be made of 304 stainless steel, 316L stainless steel, Incoloy, or Inconel.

In some aspects, the conductor core 144 can be solid or stranded copper or a copper alloy. In some aspects, the conductor core 144 can be solid or stranded aluminum or an aluminum alloy. In some aspects, the conductor core 144 can be a combination of aluminum and copper (for example, an aluminum core with copper external layer). As shown in this example, the three conductors 140 are aligned in a straight row, so as to, for example, avoid cabling damage or buckling based on differing conductor core chord spooled vs. unspooled lengths.

The example sheathing 130 can provide other advantages to the power cable 70 as well. For example, although three conductors 140 are shown in this example, it can be advantageous to run more than the three phases of conductors 140 to provide redundancy and fault tolerance to the ESP 100. Thus, in some example implementations, more than three conductors 140 can be installed within the sheathing 130. As another example, it can be advantageous to run one or more capillary lines through the sheathing 130 in addition to the conductors 140. The capillary lines (for example, one or more bores 139 of smaller diameter than bores 132) can be used for chemical injection, for example to circulate a scale or corrosion inhibitor into the wellbore. Further, the bore(s) 139 can accept data telemetry lines such as copper or fiber optics.

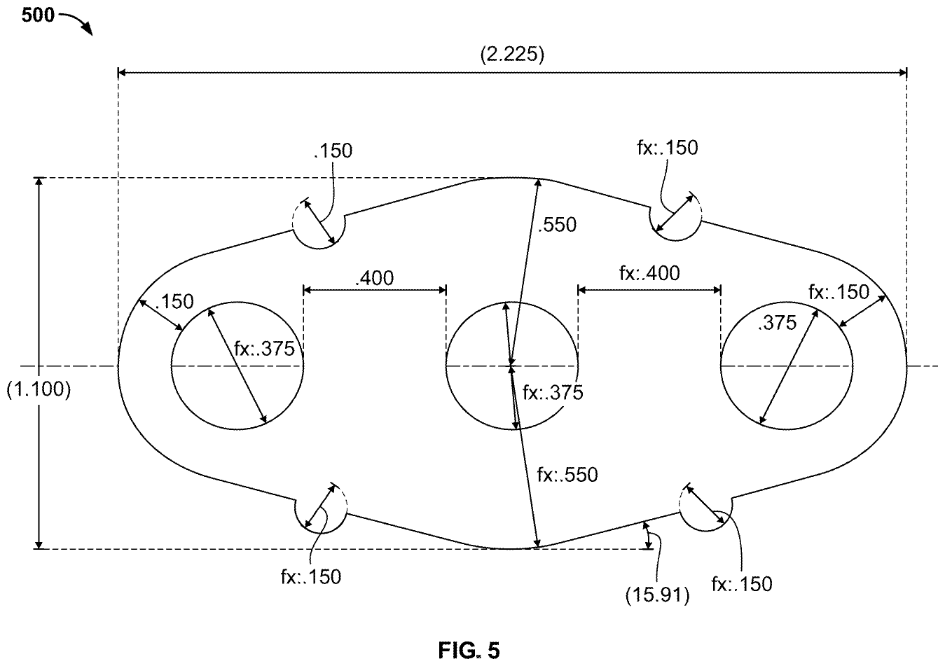

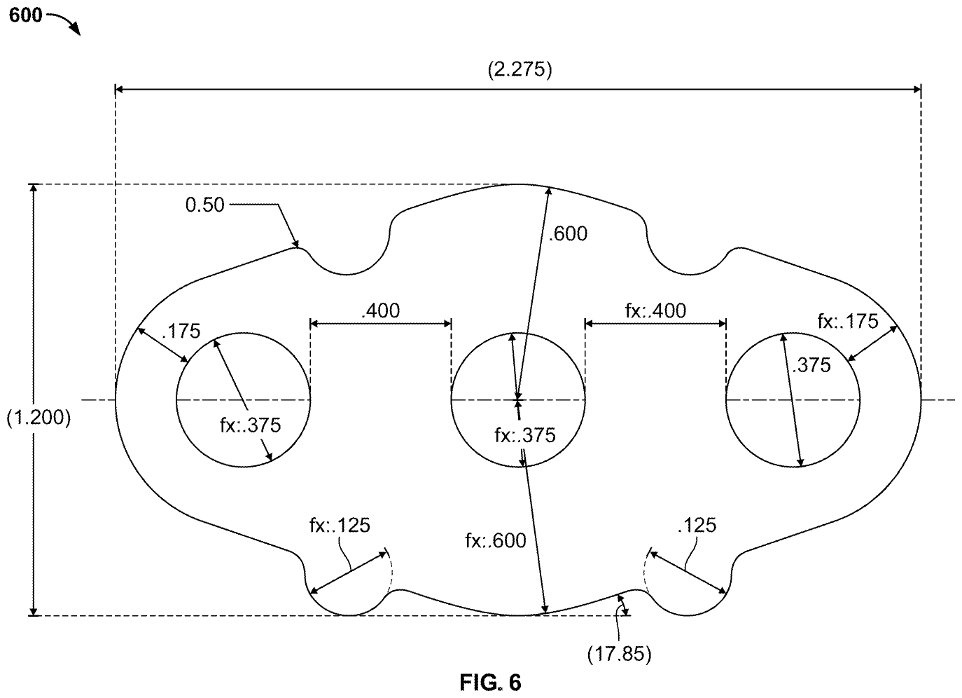

FIGS. 5 and 6 are scaled drawings of example implementations of a portion of a sheathing for an ESP power cable according to the present disclosure. FIG. 5 shows a cross section of an example sheathing 500, including exemplary dimensions of the cross-section. FIG. 6 shows a cross section of an example sheathing 600, including exemplary dimensions of the cross-section. All dimensions in FIGS. 5 and 6 are for example purposes only.

The power cable 70 (including the sheathing 130 or another sheathing according to the present disclosure) can be manufactured according to the following exemplary process. In this example, the steps are described in a particular order; however other example processes that result in the power cable 70 can be implemented in different orders than that described here. First, the conductor core 144 can be formed (as a solid wire or stranded) at a particular gauge size (for example, 2 AWG). Optionally, a coating, such as Kapton™ coating, can be applied, such as for enhanced electrical properties at high temperatures.

Next, the electrical insulation layer 142 can formed (as a thermoplastic) over the conductor core 144 and the insulated core can be spooled on storage drum.

Next, the insulated conductor core can be inserted into the steel tube 141 during a milling process. The milling process can include taking a flat steel sheet, which is rolled to a partial round shape into which the insulated conductor core is placed. The partially round steel is then milled to the full round shape of the steel tube 141 and a seam is welded and swaged to an exact size. The steel tube 141 is then cooled and the conductor core 144, now insulated and covered in the steel tube 141, is spooled onto a storage drum in long lengths of the conductor 140.

In an example of the power cable 70 that includes three conductors 140, the above referenced process can be completed three times to result in three storage drums of the conductors 140. The three drums of conductors 140 can be aligned and then fed through a thermoplastic die that is cut to the outer shape of the sheathing 130 (for example, as shown in FIG. 4A). The die maintains the conductors 140 along a line of symmetry (dotted line 183 in FIG. 4A) to be fixed in position in the sheathing matrix. The sheathing matrix material is heated to liquid, pressurized, and injected into die while the conductors 140 are continuously spooled from the storage drums. This resultant product is cooled and spooled onto shipping drums.

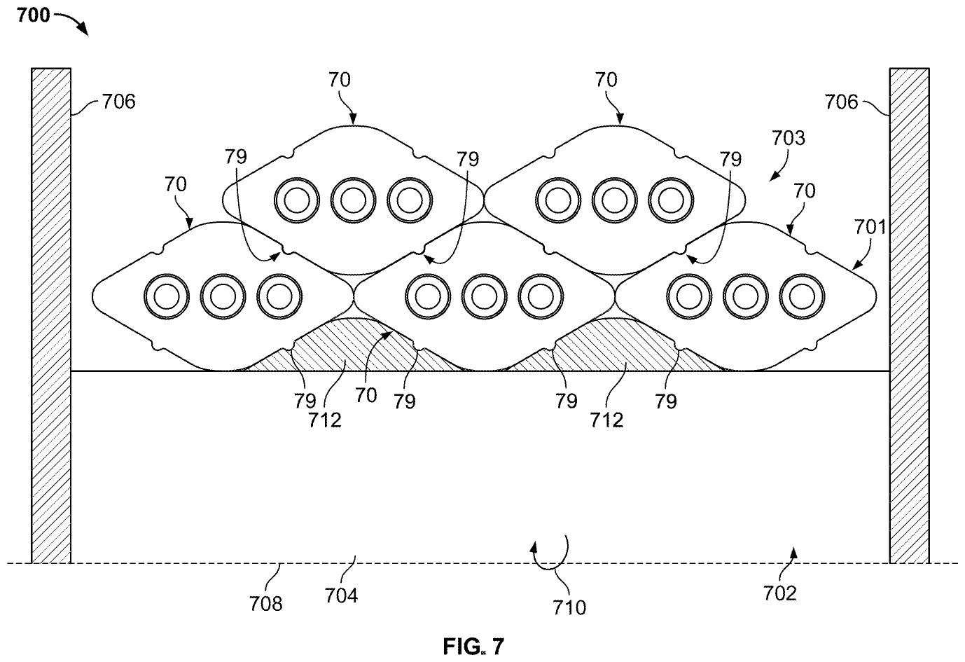

FIG. 7 is a schematic diagram of an example implementation of a spooled ESP power cable according to the present disclosure. For example, FIG. 7 shows a spooling system 700 for the power cable 70 (i.e., a single length of power cable 70) according to the present disclosure. In some aspects, the power cable 70 can be manufactured in a continuous process and spooled onto the spooling system 700 (which includes a reel 702) for QA/QC, storage, and onward shipping and subsequent use.

As shown in this example, the reel 702 can include a drum 704 (such as a storage drum) onto which the power cable 70 is spooled into successive layers 701, 703, and more if necessary. Each layer 701 and 703 are formed of two or more rotations of the power cable 70 as shown. Optionally, sides or guides 706 can retain the power cable 70 on the drum 704, which can be rotated with rotation 710 about rotational axis 708. Optionally, a spooler drum profile guide 712 can be formed on the drum 704. The shape of the guide 712 can closely match an inverse cross-sectional profile of half the cross-section of the power cable 70 as shown to secure the cable 70 onto the drum 704 during a beginning rotation.

As lengths of the power cable 70 are rolled up onto the drum 704 (for example, by a winch, not shown), pips and notches of adjacent sections of the power cable 70 can interface at interface locations 79 to secure or help secure the lengths of the power cable 70 onto the drum 704. As shown, interface locations 79 can also occur between the power cable 70 and the guides 712.

The power cable 70 can be transported to a wellbore location on the spooling system 700. On location, the spooling system 700 can be fitted to a spooler (winch) unit and positioned close to a rig floor ready for installation as the ESP 100 is installed with production tubing 45 into the wellbore 20. A (roller) funnel guide device can be placed on the rig floor to ensure the power cable 70 does not foul or become damaged during unspooling. During installation of the ESP pump 100, the power cable 70 is spooled off the drum 704, over one or more sheaves, and down into the annulus 120 between the production tubing 45 and the production casing 37.

During running of the production tubing 45 into the wellbore 20 with the power cable 70, cable clamps 90 (for example, one or two) can be installed so that the power cable 70 is constrained by the clamps 90 at or near the production packer 80, at or neat the tubing hanger 77, or both locations (or in some aspects, neither location). Thus, the ESP 100, production tubing 45, and power cable 70 are lowered into the wellbore 20 within the production casing 37. For the majority of tubing joints, the power cable is not clamped to the production tubing 45 (and not clamped with 1 clamp per 30 feet of power cable as is convention). The power cable 70 is terminated using the wellhead electrical penetrator 71 and connected to the power supply system 60 to provide for operation of the ESP 100.

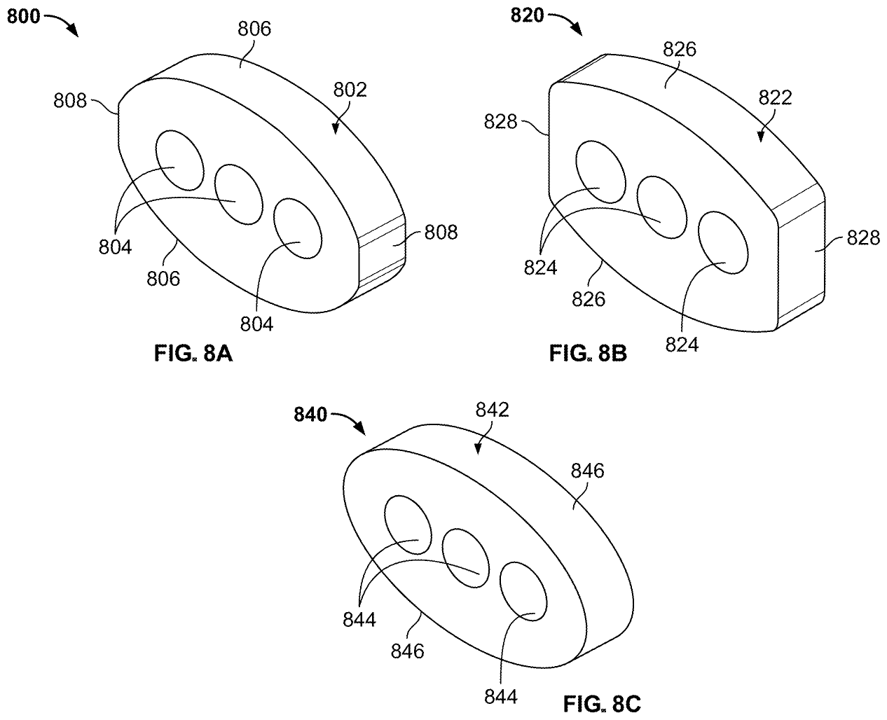

FIGS. 8A-8C are illustrations of other example implementations of a portion of a sheathing for an ESP power cable according to the present disclosure. Generally, the example sheathings 800, 820, and 840 in respective FIGS. 8A-8C have alternative cross-sectional shapes as compared to the sheathing 130, but still provide for the same or similar functionality (including buoyant properties) as the sheathing 130. In some aspects, one, some, or all of the example sheathings 800, 820, and 840 can be made of the same or similar material as described with reference to the sheathing 130. Further, although not illustrated in these figures, pips (such as pips 134) and notches (such as notches 136) can be formed on one, some, or all of the example sheathings 800, 820, and 840.

Turning first to FIG. 8A, the sheathing 800 has a substantially oval body 802 with curved sides 806 and flattened edges 808. Bores 804 are formed through the body 802, through which power conductors (such as conductors 140) can be installed. Although not shown, smaller bores (similar to bore 139) can be formed through the body 802 to allow for chemical injection or data telemetry lines such as copper or fiber optics.

The sheathing 820 has a substantially rectangular body 822 with curved sides 826 and flat sides 828. Bores 824 are formed through the body 822, through which power conductors (such as conductors 140) can be installed. Although not shown, smaller bores (similar to bore 139) can be formed through the body 822 to allow for chemical injection or data telemetry lines such as copper or fiber optics.

The sheathing 840 has an oval body 842 with curved half sides 846. Bores 844 are formed through the body 842, through which power conductors (such as conductors 140) can be installed. Although not shown, smaller bores (similar to bore 139) can be formed through the body 842 to allow for chemical injection or data telemetry lines such as copper or fiber optics.

FIGS. 4A, 4B, 5, 6, and 8A-8C show example cross-sectional shapes of a sheathing for an ESP power cable according to the present disclosure. However, other cross-sectional shapes are also contemplated in this disclosure including, for example, round, oblong, flat (rectangular with two sides much longer relative to two other sides), and other shapes.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A downhole pumping system, comprising:
a production tubing installed in a wellbore from a terranean surface to a subterranean formation;
a downhole pump coupled to a downhole end of the production tubing and configured to circulate a production fluid from the subterranean formation, through the production tubing, and to the terranean surface; and
a power cable electrically coupled to a power supply at the terranean surface and to the downhole pump and configured to supply electrical power to the downhole pump, the power cable installed in the wellbore and within a wellbore fluid, the power cable having a density sufficient for the power cable to be at least substantially neutrally buoyant in the wellbore fluid.

2. The downhole pumping system of claim 1, wherein the power cable is installed in an annulus between the production tubing and the wellbore and within the wellbore fluid in the annulus.

3. The downhole pumping system of claim 2, comprising a production casing installed in the wellbore, the power cable installed in the wellbore in the annulus between the production tubing and the production casing.

4. The downhole pumping system of claim 2, comprising no more than two cable clamps installed to secure the power cable to the production tubing.

5. The downhole pumping system of claim 4, wherein the no more than two cable clamps comprise:
a first cable clamp installed to secure the power cable to the production tubing at a first location at or near a wellbore seal installed in the annulus; and
a second cable clamp installed to secure the power cable to the production tubing at a second location at or near a tubing hanger.

6. The downhole pumping system of claim 4, wherein the no more than two cable clamps comprise:
a single cable clamp installed to secure the power cable to the production tubing at either a first location at or near a wellbore seal installed in the annulus or a second location at or near a tubing hanger.

7. The downhole pumping system of claim 1, wherein the power cable comprises:
a sheathing comprising at least one conductor bore formed therethrough; and
at least one power conductor threaded through the at least one conductor bore.

8. The downhole pumping system of claim 7, wherein the at least one conductor bore comprises three conductor bores, and the at least one power conductor comprises three power conductors, each power conductor threaded through one of the three conductor bores.

9. The downhole pumping system of claim 7, wherein the at least one power conductor comprises:
a conductor core comprising at least one electrically conductive material;
an electrical insulative layer that encloses the conductor core; and
a metallic tubing that encloses the electrical insulative layer.

10. The downhole pumping system of claim 9, wherein the at least one electrically conductive material comprises:
aluminum or an aluminum alloy;
copper or a copper alloy; or
a combination of aluminum and copper.

11. The downhole pumping system of claim 7, wherein the sheathing comprises an outer polymer encapsulation matrix and a low density filler material.

12. The downhole pumping system of claim 11, wherein the outer polymer encapsulation matrix and the low density filler material forms a syntactic collapse resistant foam.

13. The downhole pumping system of claim 7, wherein a cross-section shape of the sheathing is a substantially diamond or rhomboid shape.

14. The downhole pumping system of claim 13, wherein an outer surface of the sheathing comprises:
at least one notch that extends through at least a portion of the outer surface; and
at least one pip that extends on the portion of the outer surface, the pip shaped to interface with the notch.

15. The downhole pumping system of claim 13, wherein a density of the sheathing is about 0.0188 lb./in³.

16. The downhole pumping system of claim 13, wherein a density of the power cable is about 0.046 lb./in³.

17. The downhole pumping system of claim 2, wherein the wellbore fluid is brine or a completion fluid.

18. The downhole pumping system of claim 1, wherein the power cable is installed in the production tubing and within the wellbore fluid in the production tubing.

19. The downhole pumping system of claim 18, wherein the wellbore fluid is a production fluid.

20. The downhole pumping system of claim 18, wherein the power cable comprises:
a sheathing comprising at least one conductor bore formed therethrough, the sheathing comprising a circular cross section; and
at least one power conductor threaded through the at least one conductor bore.

21. The downhole pumping system of claim 18, wherein the power cable is unconstrained within the production tubing between a cable hanger at or near a terranean surface and a mechanical and electrical connection at the downhole pump.

22. An electrical submersible pump (ESP) power cable, comprising:
a sheathing comprising a body that comprises at least one conductor bore formed therethrough; and
at least one power conductor threaded through the at least one conductor bore, wherein the power cable has a density sufficient for the power cable to be at least substantially neutrally buoyant in a wellbore fluid in a wellbore.

23. The ESP power cable of claim 22, wherein the at least one conductor bore comprises three conductor bores, and the at least one power conductor comprises three power conductors, each power conductor threaded through one of the three conductor bores.

24. The ESP power cable of claim 22, wherein the at least one power conductor comprises:
a conductor core comprising at least one electrically conductive material;
an electrical insulative layer that encloses the conductor core; and
a metallic tubing that encloses the electrical insulative layer.

25. The ESP power cable of claim 24, wherein the at least one electrically conductive material comprises:
aluminum or an aluminum alloy;
copper or a copper alloy; or
a combination of aluminum and copper.

26. The ESP power cable of claim 22, wherein the body comprises an outer polymer encapsulation matrix and a low density filler material.

27. The ESP power cable of claim 26, wherein the outer polymer encapsulation matrix and the low density filler material forms a syntactic collapse resistant foam.

28. The ESP power cable of claim 22, wherein a cross-section shape of the body is a substantially diamond or rhomboid shape.

29. The ESP power cable of claim 22, wherein an outer surface of the body comprises:
at least one notch that extends through at least a portion of the outer surface; and
at least one pip that extends on the portion of the outer surface, the pip shaped to interface with the notch.

30. The ESP power cable of claim 22, wherein a density of the body is about 0.0188 lb./in³.

31. The ESP power cable of claim 22, wherein a density of the ESP power cable is about 0.046 lb./in³.

32. The ESP power cable of claim 22, wherein the body comprises at least one capillary bore formed therethrough.

33. The ESP power cable of claim 22, wherein the at least one capillary bore is configured to carry a data telemetry conductor or a fluid.

34. The ESP power cable of claim 22, wherein the density is sufficient for the power cable to be at least substantially neutrally buoyant in the wellbore fluid in an annulus between a production casing and a production tubing.

35. The ESP power cable of claim 22, wherein the density is sufficient for the power cable to be at least substantially neutrally buoyant in the wellbore fluid within a production tubing.

36. A method of supplying power to a downhole pump, comprising:
installing a downhole pump at or near a downhole end of a production tubing installed in a wellbore from a terranean surface to a subterranean formation;
running a power cable through the wellbore and within a wellbore fluid in the wellbore, the power cable having a density sufficient for the power cable to be at least substantially neutrally buoyant in the wellbore fluid;
electrically coupling the power cable to a power supply at the terranean surface and to the downhole pump;
supplying electrical power to the downhole pump from the power supply and through the power cable; and
operating the downhole pump to circulate a production fluid from the subterranean formation, through the production tubing, and to the terranean surface.

37. The method of claim 36, comprising:
running the production tubing into the wellbore formed from the terranean surface to the subterranean formation; and
coupling the downhole pump to the downhole end of the production tubing.

38. The method of claim 36, comprising running the power cable through the wellbore in an annulus between the production tubing and a production casing installed in the wellbore and the wellbore fluid in the annulus.

39. The method of claim 38, comprising securing the power cable to the production tubing with no more than two cable clamps.

40. The method of claim 39, wherein securing the power cable to the production tubing with no more than two cable clamps comprises:
securing the power cable to the production tubing with a first cable clamp installed at a first location at or near a wellbore seal installed in the annulus; and
securing the power cable to the production tubing with a second cable clamp installed at a second location at or near a tubing hanger.

41. The method of claim 39, wherein securing the power cable to the production tubing with no more than two cable clamps comprises:
securing the power cable to the production tubing with a single cable clamp installed at either a first location at or near a wellbore seal installed in the annulus or a second location at or near a tubing hanger.

42. The method of claim 36, wherein the power cable comprises a sheathing comprising at least one conductor bore formed therethrough; and at least one power conductor threaded through the at least one conductor bore, the method comprising:
spooling the power cable from a spooling system at or near a rig floor near an entry of the wellbore; and
supplying electrical power to the downhole pump from the power supply through the at least one power conductor.

43. The method of claim 42, wherein supplying electrical power to the downhole pump from the power supply through the at least one power conductor comprises supplying electrical power to the downhole pump from the power supply through three power conductors, each power conductor threaded through one of three conductor bores.

44. The method of claim 42, wherein supplying electrical power to the downhole pump from the power supply through the at least one power conductor comprises:
supplying electrical power to the downhole pump from the power supply through a conductor core of the at least one power conductor, the conductor core comprised of at least one electrically conductive material.

45. The method of claim 44, wherein the at least one electrically conductive material comprises:
aluminum or an aluminum alloy;
copper or a copper alloy; or
a combination of aluminum and copper.

46. The method of claim 42, wherein the power cable is spooled on a drum of the spooling system such that an outer surface of the sheathing of a first portion of the power cable interfaces at an interface location with an outer surface of the sheathing of a second portion of the power cable.

47. The method of claim 46, wherein the interface location comprises an interface between at least one notch that extends through the outer surface of the sheathing; and at least one pip that extends on the outer surface and is shaped to interface with the notch.

48. The method of claim 36, comprising:
running the power cable through the wellbore in the production tubing; and
running the downhole pump into the production tubing on the power cable acting as a downhole conveyance.
